(19) United States
(12) Patent Application Publication
(10) Pub. No.: US 2010/0248579 A1
(43) Pub. Date: Sep. 30, 2010

(54) METHOD OF MANUFACTURING PLASMA DISPLAY PANEL

(75) Inventors: Hatsumi Komaki, Osaka (JP); Shingo Takagi, Osaka (JP); Ryoji Hyuga, Osaka (JP); Tatsuo Mifune, Osaka (JP)

Correspondence Address: RATNERPRESTIA, P.O. BOX 980, VALLEY FORGE, PA, 19482, US

(73) Assignee: PANASONIC CORPORATION, Osaka (JP)

(21) Appl. No.: 12/294,516

(22) PCT Filed: Mar. 25, 2008
(86) PCT No.: PCT/JP2008/000702

§ 371 Date: Sep. 25, 2008

(30) Foreign Application Priority Data
Apr. 18, 2007 (JP) 2007-108917

(51) Int. Cl. H01J 9/00

(52) U.S. Cl. 445/58

(57) ABSTRACT

A method of manufacturing a PDP in accordance with the present invention is a method of manufacturing a PDP including a front panel having a display electrode, a light blocking layer and a dielectric layer formed on a glass substrate, and a rear panel having an electrode, a barrier rib, and a phosphor layer formed on a substrate, the front panel and the rear panel being disposed facing each other and sealed together at peripheries thereof with discharge space provided therebetween. The method includes forming the display electrode by at least a plurality of layers including metal electrode layer containing silver and a glass material, and a black layer containing a black material and a glass material; adding bismuth oxide to the dielectric layer in the content of 5% by weight or more and 25% by weight or less; and forming the dielectric layer by firing at a temperature ranging from 570° C. to 590° C.

### TECHNICAL FIELD

The present invention relates to a plasma display panel used in a display device, and the like.

### BACKGROUND ART

Since a plasma display panel (hereinafter, referred to as “PDP”) can achieve high definition and a large screen, a television of 100-inch class or more is commercialized. Recently, PDPs have been applied to high definition televisions with full specification in which the number of scan lines is twice or more than that of the conventional National Television System Committee (NTSC) system. Furthermore, from the viewpoint of environmental problems, PDPs without containing a lead component have been demanded. Furthermore, it has been necessary to reduce expensive rare metals for saving resources and reducing material costs.

A PDP basically includes a front panel and a rear panel. The front panel includes a glass substrate of sodium borosilicate glass produced by a float process; display electrodes each composed of striped transparent electrode and bus electrode formed on one main surface of the glass substrate; a dielectric layer covering the display electrodes and functioning as a capacitor; and a protective layer made of magnesium oxide (MgO) formed on the dielectric layer. On the other hand, the rear panel includes a glass substrate; striped address electrodes formed on one main surface of the glass substrate; a base dielectric layer covering the address electrodes; barrier ribs formed on the base dielectric layer; and phosphor layers formed between the barrier ribs and emitting red, green and blue light, respectively.

The front panel and the rear panel are hermetically sealed so that their surfaces having electrodes face each other. Discharge gas of Ne—Xe is filled in discharge space partitioned by the barrier ribs at a pressure ranging from 400 Torr to 600 Torr. The PDP realizes a color image display by selectively applying a video signal voltage to a display electrode so as to cause electric discharge, thus exciting a phosphor layer of each color with ultraviolet ray generated by the electric discharge so as to emit red, green and blue light.

For the bus electrode of the display electrode, a silver electrode for securing electric conductivity is used. For the dielectric layer, a low melting point glass containing lead oxide as a main component is used. However, from the viewpoint of recent environmental problems, examples in which a dielectric layer does not contain a lead component have been disclosed (see, for example, patent documents 1, 2, 3 and 4).

Furthermore, an example in which a glass material used for forming an electrode contains a predetermined amount of bismuth oxide is also disclosed (see, for example, patent document 5).

Recently, PDPs have been applied to high definition televisions with full specification in which the number of scan lines is twice or more than that of a conventional NTSC system, and at the same time, the luminance has been enhanced and the contrast has been improved.

However, when a glass material without containing a lead component of a dielectric layer and an electrode, which is used from the viewpoint of environmental problems, are used, the black luminance caused by a black layer of the display electrode or a light blocking layer is deteriorated and the contrast is reduced. Consequently, an excellent image quality cannot be secured.

Furthermore, for resources saving and because of rise in material cost, and the like, use of expensive and rare metals is required to be reduced. However, depending upon the selection of components of black materials of the black layer and the light blocking layer, the resistance value (hereinafter, referred to as “contact resistance value”) in the direction perpendicular to a substrate from a metal electrode as a bus line of a display electrode to a transparent electrode is increased and the consumption electric power is increased, thus affecting the image quality.

[Patent Document 1] Japanese Patent Application Unexamined Publication No. 2003-128430

[Patent Document 2] Japanese Patent Application Unexamined Publication No. 2002-053342

[Patent Document 3] Japanese Patent Application Unexamined Publication No. 2001-045877

[Patent Document 4] Japanese Patent Application Unexamined

Publication No. H9-050769

[Patent Document 5] Japanese Patent Application Unexamined Publication No. 2000-048645

### SUMMARY OF THE INVENTION

A method of manufacturing a PDP in accordance with the present invention is a method of manufacturing a PDP including a front panel having a display electrode, a light blocking layer and a dielectric layer formed on a glass substrate, and a rear panel having an electrode, a barrier rib, and a phosphor layer formed on a substrate, the front panel and the rear panel being disposed facing each other and sealed together at peripheries thereof with discharge space provided therebetween. The method includes forming the display electrode by at least a plurality of layers including a metal electrode layer containing silver and a glass material, and a black layer containing a black material and a glass material; adding bismuth oxide to the dielectric layer in the content of 5% by weight or more and 25% by weight or less; and forming the dielectric layer by firing at a temperature ranging from 570° C. to 590° C.

Furthermore, the method of manufacturing a PDP of the present invention may further include adding at least any one of cobalt (Co), nickel (Ni), copper (Cu), oxide of cobalt (Co), oxide of nickel (Ni), and oxide of copper (Cu) to the black layer.

Furthermore, in the method of manufacturing a PDP of the present invention, in the forming of the dielectric layer by firing a dielectric material, the light blocking layer contains a glass material, and the dielectric material may fired at a temperature lower than a softening point of the glass material.

Furthermore, the method of manufacturing a PDP of the present invention may further include forming the light blocking layer by adding at least bismuth oxide to the glass material of the light blocking layer in the content of 5% by weight or more and 25% by weight or less.

### BRIEF DESCRIPTION OF THE DRAWINGS

FIG. 1 is a perspective view showing a structure of a PDP in accordance with an exemplary embodiment of the present invention.

FIG. 2 is a sectional view showing a configuration of a front panel of the PDP according to an embodiment of the invention.

FIG. 3 is a graph showing the degree of black of a light blocking layer with respect to an amount of bismuth oxide in a dielectric layer.

FIG. 4 is a graph showing the degree of black of a light blocking layer with respect to a firing temperature of a dielectric layer.

FIG. 5 is a graph showing a contact resistance value with respect to components contained in a black electrode.

FIG. 6 is a graph showing a contact resistance value with respect to a content of bismuth oxide in a dielectric layer.

FIG. 7 is a graph showing a contact resistance value with respect to a content of bismuth oxide in a glass material of a white electrode.

### REFERENCE MARKS IN THE DRAWINGS

1 PDP
2 front panel
3 front glass substrate
4 scan electrode
4a, 5a transparent electrode
4b, 5b metal bus electrode
5 sustain electrode
6 display electrode
7 light blocking layer
8 dielectric layer
9 protective layer
10 rear panel
11 rear glass substrate
12 address electrode
13 base dielectric layer
14 barrier rib
15 phosphor layer
16 discharge space
41b, 51b black electrode
42b, 52b white electrode
81 first dielectric layer
82 second dielectric layer

### DETAILED DESCRIPTION OF THE PREFERRED EMBODIMENTS

Hereinafter, a PDP in accordance with an exemplary embodiment of the present invention is described with reference to drawings.

### Exemplary Embodiment

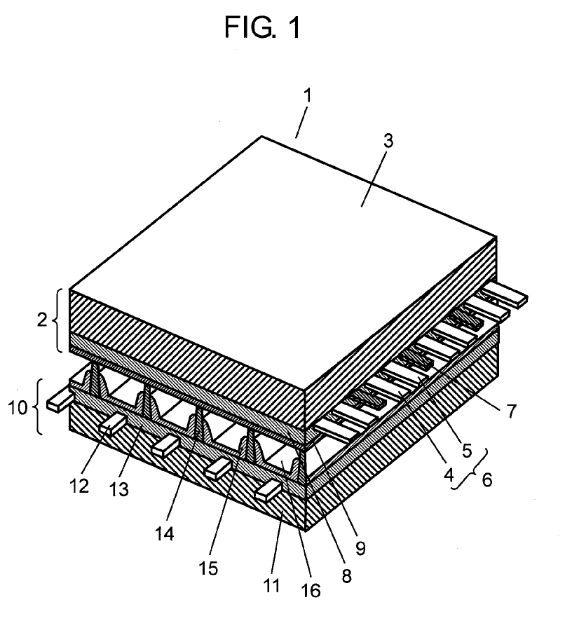

FIG. 1 is a perspective view showing a structure of a PDP in accordance with an exemplary embodiment of the present invention. The basic structure of the PDP is the same as that of a general AC surface-discharge type PDP. As shown in FIG. 1, PDP 1 includes front panel 2 including front glass substrate 3, and the like, and rear panel 10 including rear glass substrate 11, and the like. Front panel 2 and rear panel 10 are disposed facing each other and hermetically sealed together at the peripheries thereof with a sealing material including a glass frit, and the like. In discharge space 16 inside the sealed PDP 1, discharge gas such as Ne and Xe, is filled in at a pressure ranging from 400 Torr to 600 Torr.

A plurality of stripe-like display electrodes 6 each composed of a pair of scan electrode 4 and sustain electrode 5 and light blocking layers 7 are disposed in parallel to each other on front glass substrate 3 of front panel 2. Dielectric layer 8 functioning as a capacitor is formed so as to cover display electrodes 6 and light blocking layers 7 on front glass substrate 3. In addition, protective layer 9 made of, for example, magnesium oxide (MgO) is formed on the surface of dielectric layer 8.

Furthermore, on rear glass substrate 11 of rear panel 10, a plurality of address electrodes 12 as stripe-like electrodes are disposed in parallel to each other in the direction orthogonal to scan electrodes 4 and sustain electrodes 5 of front panel 2, and they are covered with base dielectric layer 13. In addition, barrier ribs 14 with a predetermined height for partitioning discharge space 16 are formed between address electrodes 12 on base dielectric layer 13. Phosphor layers 15 emitting red, blue and green light by ultraviolet ray are sequentially formed by coating in grooves between barrier ribs 14 for each address electrode 12. Discharge cells are formed in positions in which scan electrodes 4, sustain electrodes 5 and address electrodes 12 intersect each other. The discharge cells having red, blue and green phosphor layers 15 arranged in the direction of display electrode 6 function as pixels for color display.

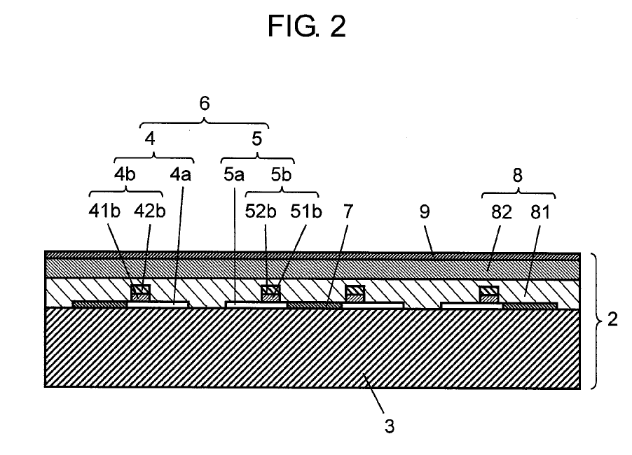

FIG. 2 is a sectional view showing a configuration of front panel 2 of the PDP in accordance with an exemplary embodiment of the present invention. FIG. 2 is shown turned upside down with respect to FIG. 1. As shown in FIG. 2, display electrodes 6 each composed of scan electrode 4 and sustain electrode 5 and light blocking layers 7 are patterned on front glass substrate 3 produced by, for example, a float method. Scan electrode 4 and sustain electrode 5 include transparent electrodes 4a and 5a made of indium tin oxide (ITO), tin oxide (SnO₂), or the like, and metal bus electrodes 4b and 5b formed on transparent electrodes 4a and 5a, respectively. Metal bus electrodes 4b and 5b are used for the purpose of providing the conductivity in the longitudinal direction of transparent electrodes 4a and 5a and formed of a conductive material containing a silver (Ag) material as a main component. Furthermore, metal bus electrodes 4b and 5b include black electrodes 41b and 51b and white electrodes 42b and 52b.

Dielectric layer 8 includes at least two layers, that is, first dielectric layer 81 and second dielectric layer 82. First dielectric layer 81 is provided for covering transparent electrodes 4a and 5a, metal bus electrodes 4b and 5b, and light blocking layers 7 formed on front glass substrate 3. Second dielectric layer 82 is formed on first dielectric layer 81. In addition, protective layer 9 is formed on second dielectric layer 82.

Next, a method of manufacturing a PDP is described. Firstly, scan electrodes 4, sustain electrodes 5 and light blocking layers 7 are formed on front glass substrate 3. Transparent electrodes 4a and 5a and metal bus electrodes 4b and 5b are formed by patterning by, for example, a photolithography method. Transparent electrodes 4a and 5a are formed by, for example, a thin film process. Metal bus electrodes 4b and 5b are formed by firing a paste including conductive black particles or a silver material at a predetermined temperature and solidifying it. Furthermore, light blocking layer 7 is similarly formed by patterning a paste including a black material by a method of screen printing or a method of forming a black material over the entire surface of the glass substrate, then carrying out a photolithography method, and firing it.

As a specific procedure for forming metal bus electrodes 4b and 5b, the following procedure is generally carried out. A paste including a black material is printed on front glass substrate 3 and dried, and then patterned by a photolithography method so as to form light blocking layer 7. Furthermore, thereon, a paste including a pigment and a paste including conductive particles are printed and dried, repeatedly. Thereafter, they are patterned by a photolithography method so as to form metal bus electrodes 4b and 5b composed of black electrodes 41b and 51b and white electrodes 42b and 52b. Herein, in order to improve the contrast at the time of image display, black electrodes 41b and 51b are formed on the lower layer (at the side of front glass substrate 3) and white electrodes 42b and 52b are formed on the upper layer.

In the exemplary embodiment of the present invention, black electrodes 41b and 51b of metal bus electrodes 4b and 5b and light blocking layer 7 are made of the same material and manufactured by the same process. Since the present invention is a technology for improving the degree of black, in the exemplary embodiment of the present invention, the degree of black of light blocking layer 7 becomes excellent. Therefore, the effect of the present invention can be strengthened.

Next, a dielectric paste is coated on front glass substrate 3 by, for example, a die coating method so as to cover scan electrodes 4, sustain electrodes 5 and light blocking layers 7, thus forming a dielectric paste layer (dielectric glass layer). After the dielectric paste is coated, it is stood still for a predetermined time. Thereby, the surface of the coated dielectric paste is leveled and flattened. Thereafter, by firing and solidifying the dielectric paste layer, dielectric layer 8 covering scan electrodes 4, sustain electrodes 5 and light blocking layers 7 is formed. In the exemplary embodiment of the present invention, by repeating at least coating of these dielectric pastes, two-layered dielectric layer 8 including first dielectric layer 81 and second dielectric layer 82 is formed. Note here that the dielectric paste is a coating material including dielectric glass powder, a binder and a solvent. Next, protective layer 9 made of magnesium oxide (MgO) is formed on dielectric layer 8 by a vacuum evaporation method. With the above-mentioned process, predetermined component members are formed on front glass substrate 3. Thus, front panel 2 is completed.

On the other hand, rear panel 10 is formed as follows. Firstly, a material layer as components for address electrode 12 is formed on rear glass substrate 11 by a method of screen printing a paste including a silver (Ag) material, a method of forming a metal film over the entire surface, and then patterning it by a photolithography method, or the like. The material layer is fired at a predetermined temperature so as to form address electrode 12. Next, a dielectric paste is coated by, for example, a die coating method so as to cover address electrodes 12 on rear glass substrate 11 on which address electrodes 12 are formed. Thus, a dielectric paste layer is formed. Thereafter, by firing the dielectric paste layer, base dielectric layer 13 is formed. Note here that a dielectric paste is a coating material including dielectric glass powder, a binder, and a solvent.

Next, by coating a barrier rib formation paste including materials for barrier ribs on base dielectric layer 13 and patterning it into a predetermined shape, a barrier rib material layer is formed, and then fired. Thus, barrier ribs 14 are formed. Herein, a method of patterning the barrier rib formation paste coated on base dielectric layer 13 may include a photolithography method and a sand-blast method. Next, a phosphor paste including a phosphor material is coated between neighboring barrier ribs 14 on base dielectric layer 13 and on the side surfaces of barrier ribs 14, and fired. Thus, phosphor layer 15 is formed. As mentioned above, predetermined component members are formed on rear glass substrate 11, and rear panel 10 is completed.

In this way, front panel 2 and rear panel 10, which include predetermined component members, are disposed facing each other such that scan electrodes 4 and address electrodes 12 are disposed orthogonal to each other, and sealed together at the peripheries thereof with a glass frit. Discharge gas including, for example, Ne and Xe, is filled in discharge space 16. Thus, PDP 1 is completed.

Next, the details of display electrode 6 and dielectric layer 8 of front panel 2 are described. Firstly, display electrode 6 is described. Indium tin oxide (ITO) having a thickness of about 0.12 μm is formed over the entire surface of front glass substrate 3 by a sputtering method. Thereafter, by a photolithography method, striped transparent electrodes 4a and 5a having a width of 150 μm are formed.

Then, a photosensitive paste is coated over the entire upper surface of front glass substrate 3 by a printing method, or the like, to form a black electrode paste layer as a black layer. Note here that a photosensitive paste to be formed into a black layer includes 5% to 40% inclusive by weight of a black material, that is, at least one of black metal particles of cobalt (Co), black metal particles of nickel (Ni), black metal particles of copper (Cu), metal oxide of cobalt (Co), metal oxide of nickel (Ni), metal oxide of copper (Cu), composite metal oxide of cobalt (Co), composite metal oxide of nickel (Ni), and composite metal oxide of copper (Cu); 10% to 40% inclusive by weight of a glass material; and 30% to 60% inclusive by weight of photosensitive organic binder component including a photosensitive polymer, a photosensitive monomer, a photopolymerization initiator, a solvent, and the like. That is to say, a step of adding at least one of cobalt (Co), nickel (Ni), copper (Cu), oxide of cobalt (Co), and oxide of nickel (Ni), oxide of copper (Cu) to the black layer is carried out. That is to say, display electrode 6 are formed of a plurality of layers including at least a metal electrode layer containing silver and a glass material and a black layer containing a black material and a glass material.

Note here that the glass material of the black electrode paste layer constituting metal bus electrodes 4b and 5b includes at least 5% to 25% inclusive by weight of bismuth oxide (Bi₂O₃) and has a softening point of higher than 500° C. That is to say, as mentioned above, similar to black electrodes 41b and 51b of metal bus electrodes 4b and 5b, light blocking layer 7 is formed by adding at least bismuth oxide (Bi₂O₃) to a glass material of light blocking layer 7 in the content of 5% or more and 25% inclusive by weight or less. Note here that the black metal particles, metal oxide, and composite metal oxide of cobalt (Co), nickel (Ni), and copper (Cu) as the black material mentioned above also function as a partially conductive material.

Next, a photosensitive paste is coated on a black electrode paste layer by a printing method or the like so as to form a white electrode paste layer. The photosensitive paste includes at least 70% to 90% inclusive by weight of silver (Ag) particles; 1% to 15% inclusive by weight of glass material; and 8% to 30% inclusive by weight of photosensitive organic binder component including a photosensitive polymer, a photosensitive monomer, a photopolymerization initiator, a solvent, and the like. Furthermore, the glass material of the white electrode paste layer includes 5% to 25% inclusive by weight of bismuth oxide (Bi₂O₃) and has a softening point of more than 550° C.

These black electrode paste layer and white electrode paste layer, which are coated over the entire surface, are patterned by using a photolithography method. Then, the patterned black electrode paste layer and white electrode paste layer are fired at a temperature ranging from 550° C. to 600° C. Thus, black electrodes 41b and 51b and white electrodes 42b and 52b having a line width of about 60 μm are formed on transparent electrodes 4a and 5a.

Thus, in the exemplary embodiment of the present invention, cobalt (Co), nickel (Ni), and copper (Cu) are used for black electrodes 41b and 51b. On the other hand, in a conventional technology, by allowing black electrodes 41b and 51b and light blocking layer 7 to contain chromium (Cr), manganese (Mn) and iron (Fe), the conductivity and the degree of black are secured. However, the present inventors have found that use of chromium (Cr), manganese (Mn), and iron (Fe) for black electrodes 41b and 51b tends to increase the contact resistance value on the layer interface between black electrodes 41b and 51b and white electrodes 42b and 52b, and to increase the resistance value of the entire electrode layer. Furthermore, it is determined that this tendency is also dependent upon components of the glass material of black electrodes 41b and 51b, or components of dielectric layer 8, or the like.

This phenomenon is described below. In general, silvers (Ag) included in white electrodes 42b and 52b are brought into contact with each other by heat treatment in firing of the electrode and firing of the dielectric layer, and thereby the conductivity of the electrode is expressed. However, in general, the components such as conductive material and black material included in black electrodes 41b and 51b move and diffuse to white electrodes 42b and 52b in firing of the electrode and firing of the dielectric layer mentioned above, preventing silvers (Ag) from being brought into contact with each other. However, when cobalt (Co), nickel (Ni), and copper (Cu) are used for black electrodes 41b and 51b, diffusion of components such as conductive material and black material included in black electrodes 41b and 51b to white electrodes 42b and 52b is suppressed. As a result, silvers (Ag) are not prevented from being brought into contact with each other. Therefore, it is thought that contact resistance value on the layer interface between black electrodes 41b and 51b and white electrodes 42b and 52b can be reduced.

On the other hand, when components of chromium (Cr), manganese (Mn) and iron (Fe) are contained as the black material or the conductive material in the black electrode, the components such as the conductive material and the black material contained in the black electrodes 41b and 51b diffuse to white electrodes 51b and 52b at the time of firing. As a result, the diffused components prevent silvers (Ag) from being brought into contact with each other. Thus, the above-mentioned contact resistance value on the layer interface is increased.

Furthermore, a conventional technology also discloses a means for securing the degree of black and the conductivity by allowing black electrodes 41b and 51b or light blocking layer 7 to contain ruthenium (Ru). However, since ruthenium (Ru) is expensive and rare metal, use of ruthenium (Ru) leads to an increase in the material cost. Therefore, PDPs whose screen size is increased is significantly affected by even an increase of the partial cost. In this way, the exemplary embodiment of the present invention does not substantially use ruthenium (Ru), so that it can have advantageous effect over a conventional technology from the viewpoint of reducing material costs or saving resources.

Furthermore, it is preferable that the glass materials used for black electrodes 41b and 51b and white electrodes 42b and 52b contain 5% to 25% inclusive by weight of bismuth oxide (Bi₂O₃) and furthermore, 0.1% by weight or more and 7% by weight or less of at least one of molybdenum oxide (MoO₃) and tungsten oxide (WO₃). Note here that instead of molybdenum oxide (MoO₃) and tungsten oxide (WO₃), 0.1% to 7% inclusive by weight of at least one selected from cerium oxide (CeO₂), copper oxide (CuO), cobalt oxide (Co₂O₃), vanadium oxide (V₂O₇), and antimony oxide (Sb₂O₃) may be included.

Furthermore, as the components other than the components mentioned above, a material composition that does not include a lead component, for example, 0% to 40% inclusive by weight of zinc oxide (ZnO), 0% to 35% inclusive by weight of boron oxide (B₂O₃), 0% to 15% inclusive by weight of silicon oxide (SiO₂) and 0% to 10% inclusive by weight of aluminum oxide (Al₂O₃) may be contained. The contents of such material compositions are not particularly limited, and the contents of material compositions may be around the range of conventional technology.

In the present invention, the glass material is made to have a softening point temperature of 500° C. or higher, and the firing temperature is made to be a range from 550° C. to 600° C. As in the conventional technology, when the softening point of the glass material is as low as a range from 450° C. to 500° C., the firing temperature is higher than the softening point of the glass material by about 100° C. Therefore, highly reactive bismuth oxide (Bi₂O₃) itself vigorously reacts with silver (Ag) or black metal particles or an organic binder component in the paste. As a result, bubbles are generated in metal bus electrodes 4b and 5b and dielectric layer 8, deteriorating the withstand voltage performance of dielectric layer 8. On the other hand, according to the present invention, when the softening point of the glass material is made to be 500° C. or higher, the reactivity between bismuth oxide (Bi₂O₃) and silver (Ag), black metal particles or an organic component is deteriorated, and the generation of bubbles is reduced. However, it is not desirable that the softening point of the glass material is made to 600° C. or higher because the adhesiveness of metal bus electrodes 4b and 5b with respect to transparent electrodes 4a and 5a or front glass substrate 3 or with respect to dielectric layer 8 is deteriorated.

Next, first dielectric layer 81 and second dielectric layer 82 constituting dielectric layer 8 of front panel 2 are described in detail. A dielectric material of first dielectric layer 81 includes the following material compositions. That is to say, the material includes 5% to 25% inclusive by weight of bismuth oxide (Bi₂O₃) and 0.5% to 15% inclusive by weight of calcium oxide (CaO). Furthermore, it includes 0.1% to 7% inclusive by weight of at least one selected from molybdenum oxide (MoO₃), tungsten oxide (WO₃), cerium oxide (CeO₂), and manganese oxide (MnO₂).

Furthermore, it includes 0.5% to 12% inclusive by weight of at least one selected from strontium oxide (SrO) and barium oxide (BaO).

Note here that it may include 0.1% to 7% inclusive by weight of at least one selected from copper oxide (CuO), chromium oxide (Cr₂O₃), cobalt oxide (CO₂O₃), vanadium oxide (V₂O₇) and antimony oxide (Sb₂O₃), instead of molybdenum oxide (MoO₃), tungsten oxide (WO₃), cerium oxide (CeO₂), and manganese oxide (MnO₂).

Furthermore, as the components other than the components mentioned above, a material composition that does not include a lead component, for example, 0% to 40% inclusive by weight of zinc oxide (ZnO), 0% to 35% inclusive by weight of boron oxide (B₂O₃), 0% to 15% inclusive by weight of silicon oxide (SiO₂) and 0% to 10% inclusive by weight of aluminum oxide (Al₂O₃) may be contained. The contents of such material compositions are not particularly limited, and the contents of material compositions may be around the range of conventional technology.

The dielectric materials including these composition components are ground to have an average particle diameter ranging from 0.5 μm to 2.5 μm by using a wet jet mill or a ball mill. Thus, dielectric material powder is formed. Then, 55% to 70% inclusive by weight of this dielectric material powder and 30% to 45% inclusive by weight of binder component are well kneaded by using three rolls to form a first dielectric layer paste to be used in die coating or printing.

Then, this first dielectric layer paste is printed on front glass substrate 3 by a die coating method or a screen printing method so as to cover display electrodes 6, dried, and then fired at a temperature ranging from of 575° C. to 590° C., that is, a slightly higher temperature than the softening point of the dielectric material.

Next, second dielectric layer 82 is described. A dielectric material of second dielectric layer 82 includes the following material compositions. That is to say, the material composition includes 5% to 25% inclusive by weight of bismuth oxide (Bi₂O₃) and 6.0% to 28% inclusive by weight of barium oxide (BaO). Furthermore, it includes 0.1% to 7% inclusive by weight of at least one selected from molybdenum oxide (MoO₃), tungsten oxide (WO₃), cerium oxide (CeO₂), and manganese oxide (MnO₂).

Furthermore, it includes 0.8% to 17% inclusive by weight of at least one selected from calcium oxide (CaO) and strontium oxide (SrO).

Note here that it may include 0.1% to 7% inclusive by weight of at least one selected from copper oxide (CuO), chromium oxide (Cr₂O₃), cobalt oxide (CO₂O₃), vanadium oxide (V₂O₇) and antimony oxide (Sb₂O₃), instead of molybdenum oxide (MoO₃), tungsten oxide (WO₃), cerium oxide (CeO₂), and manganese oxide (MnO₂).

Furthermore, as the components other than the components mentioned above, a material composition that does not include a lead component, for example, 0% to 40% inclusive by weight of zinc oxide (ZnO), 0% to 35% inclusive by weight of boron oxide (B₂O₃), 0% to 15% inclusive by weight of silicon oxide (SiO₂) and 0% to 10% inclusive by weight of aluminum oxide (Al₂O₃) may be contained. The contents of such material compositions are not particularly limited, and the contents of material compositions may be around the range of conventional technology.

The dielectric materials including these composition components are ground to have an average particle diameter ranging from 0.5 μm to 2.5 μm by using a wet jet mill or a ball mill. Thus, dielectric material powder is formed. Then, 55% to 70% inclusive by weight of this dielectric material powder and 30% to 45% inclusive by weight of binder component are well kneaded by using three rolls to form a second dielectric layer paste to be used in die coating or printing. Then, this second dielectric layer paste is printed on first dielectric layer 81 by a screen printing method or a die coating method, dried, and fired at a temperature ranging from 550° C. to 590° C., that is, a slightly higher temperature than the softening point of the dielectric material.

As the film thickness of dielectric layer 8 is smaller, the effect of improving the panel luminance and reducing the discharge voltage becomes remarkable. Therefore, it is desirable that the film thickness is made to be as small as possible within a range in which a withstand voltage is not reduced. From the viewpoint of such conditions and visible light transmittance, in the exemplary embodiment of the present invention, the film thickness of dielectric layer 8 is set to be 41 μm or less, that of first dielectric layer 81 is set to be a range from 5 μm to 15 μm, and that of second dielectric layer 82 is set to be a range from 20 μm to 36 μm

As mentioned above, the amount of bismuth oxide (Bi₂O₃) included in dielectric layer 8 of both first dielectric layer 81 and second dielectric layer 82 in the present invention is made to be 5% to 25% inclusive by weight as mentioned above. When the amount of bismuth oxide (Bi₂O₃) contained in dielectric layer 8 is made to be within this range, the degree of black of the PDP can be enhanced, and the desired softening point and dielectric constant of dielectric layer 8 can be achieved. Note here that it is not necessary that the amount of bismuth oxide (Bi₂O₃) of first dielectric layer 81 and the amount of second dielectric layer 82 are equal to each other.

The thus manufactured PDP front panel has an excellent degree of black and a low contact resistance value of the metal electrode. When it is used as a panel, a PDP having an excellent contrast at the time of image display can be obtained.

### Example

In order to confirm the effects in the exemplary embodiment of the present invention, test samples having a configuration of a front panel that is adapted to a 42-inch high definition television are produced and evaluated.

In the evaluation of the degree of black, samples, in which light blocking layer 7 is formed on a glass substrate by the above-mentioned method and dielectric layer 8 is further formed so as to cover light blocking layer 7 by the above-mentioned method, are produced and evaluated for performance.

In general, lightness L* is measured by the method specified in JISZ8722 (color measuring method) and JISZ8729 (color displaying method-L*a*b* colorimetric system and L*u*v* colorimetric system). In the exemplary embodiment of the present invention, the degree of black is represented by using the L*a*b* colorimetric system. A low L* value means a strong (good) degree of black. When L* value is low, the contrast is enhanced when an image is displayed on a PDP. In this exemplary embodiment of the present invention, L* value is measured by using a spectral color difference meter NF999 (product of Nippon Denshoku).

The measurement samples are patterned by the same technique as mentioned above so that the measurement region has a size of 10 mm square. In the measurement, white sheets are laminated on the side of the film surface and measurement is carried out from the side of the glass substrate (side of the image display). The measurement is carried out at three different points in a 42-inch substrate and the average value of three measurement values is employed as a measurement result.

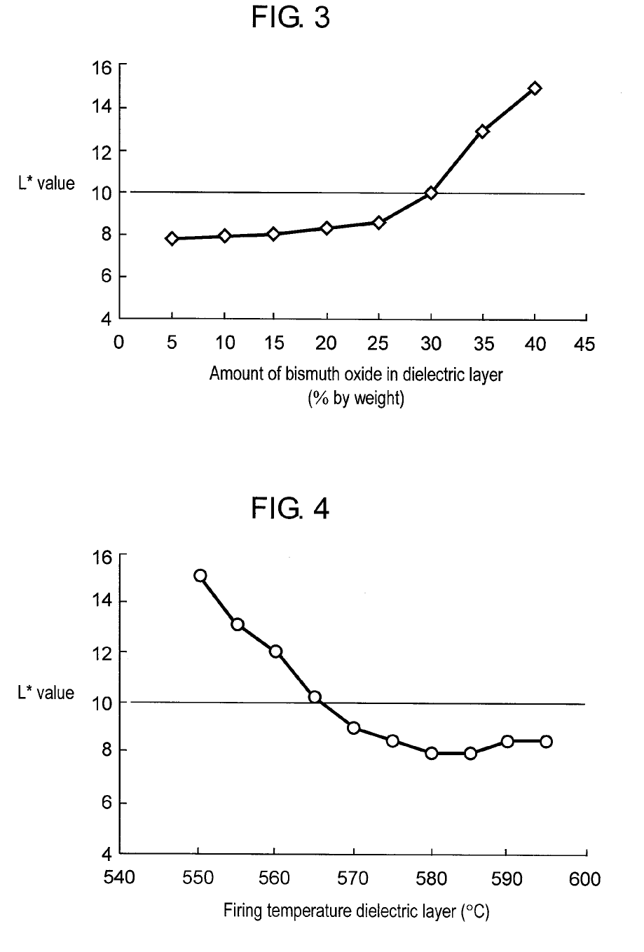

FIG. 3 is a graph showing the change of the degree of black, L* value of light blocking layer 7 with respect to the amount of bismuth oxide (Bi₂O₃) in dielectric layer 8. In the measurement conditions by the present inventors, when L* value of light blocking layer 7 is 10 or less in the image display of a PDP, an excellent contrast can be obtained. Based on this, as shown in FIG. 3, L* value is 10 or less when the amount of bismuth oxide (Bi₂O₃) in dielectric layer 8 is 5% to 30% inclusive by weight.

Although the detailed cause of this phenomenon is not clarified, it is thought to be generated due to an effect of bismuth oxide (Bi₂O₃) in dielectric layer 8 (in particular, first dielectric layer 81 in the exemplary embodiment of the present invention) that is in contact with the rear surface at the display side of light blocking layer 7 or the end portions of black electrodes 41b and 51b. It is estimated that, due to this effect, black metal particles, metal oxide and composite metal oxide of cobalt (Co), nickel (Ni) and copper (Cu) as a black materials diffuse to the side of front glass substrate 3, that is, the image display surface and improve the degree of black.

Furthermore, as the evaluation of the degree of black, the dependency of the degree of black on the firing temperature of dielectric layer 8 is also examined. FIG. 4 is a graph showing a relation between the firing temperature of dielectric layer 8 and the degree of black of light blocking layer 7. As shown in FIG. 4, L* value is 10 or less when the firing temperature of dielectric layer 8 is 570° C. or higher. Furthermore, when the firing temperature of dielectric layer 8 is more than 590° C., L* value tends to be increased. Therefore, it is desirable that dielectric layer 8 is fired at a temperature of 570° C. or higher and 590° C. or lower.

This phenomenon is thought to be generated because the glass materials included in dielectric layer 8 and light blocking layer 7 are sufficiently softened when dielectric layer 8 is fired at a temperature ranging from 570° C. to 590° C. and, due to this effect, the black material in light blocking layer 7 moves to the side of the glass substrate (the side of the image display) so as to improve the degree of black. Then, this phenomenon appears remarkably when the softening point of the glass material in light blocking layer 7 is lower than the firing temperature of dielectric layer 8. Therefore, it is desirable that light blocking layer 7 contains a glass material and a dielectric material that forms dielectric layer 8 is fired at a temperature lower than the softening point of the glass material.

Furthermore, samples, in which black electrodes 41b and 51b and white electrodes 42b and 52b instead of light blocking layer 7 are formed, are produced and the degree of black of the samples are measured similarly. As a result, the reduction in the degree of black is large in the samples using light blocking layer 7 as mentioned above. This is thought to be because dielectric layer 8 is brought into direct contact with the black layer, so that the effect of the material and the process of dielectric layer 8 on the degree of black appears remarkably. Therefore, in the PDP produced in this exemplary embodiment of the present invention, L* value tends to be reduced in light blocking layer 7 than in black electrodes 41b and 51b. Thus, even when L* value of the portion of black electrodes 41b and 51b closer to the discharge region inside in discharge cell is reduced, the reflection of light emission is reduced or absorption thereof is increased. As a result, the luminance of the light emission at the time of image display is reduced and contrast is not improved. However, when L* value of light blocking layer 7 is reduced, the loss of luminance can be suppressed, thus improving the contrast.

Next, an examination of the contact resistance value of display electrode 6 is described. In order to evaluate the contact resistance value of display electrode 6, transparent electrodes 4a and 5a, black electrodes 41b and 51b and white electrodes 42b and 52b are respectively formed on a glass substrate by the above-mentioned method, and dielectric layer 8 is further formed so as to cover these electrodes. Thus, test samples are produced. Then, by measuring the resistance value of these test samples by using a tester, the performance was evaluated. In the samples, a lead-out terminal is formed in order to remove the contact resistance of the dielectric itself, and the contact resistance of dielectric layer 8 is excluded.

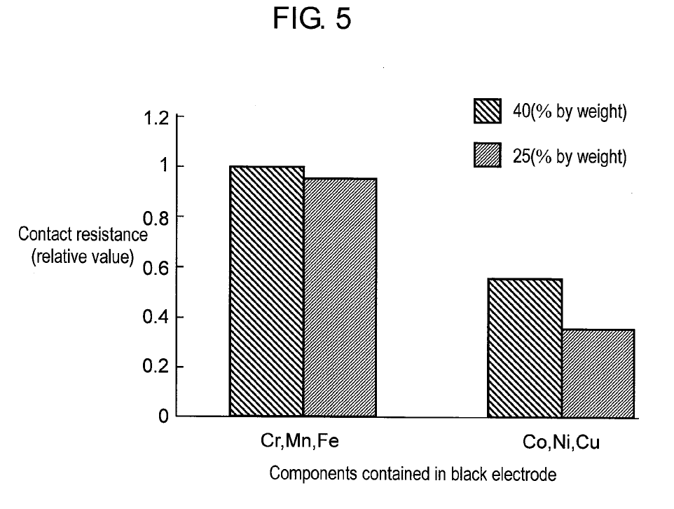

FIG. 5 is a graph showing the property difference of the contact resistance with respect to components contained in black electrodes 41b and 51b. Furthermore, the contact resistance values in the case where the content of bismuth oxide (Bi₂O₃) in dielectric layer 8 is set to 25% and 40% inclusive by weight are comparatively examined. Note here that the contact resistance value is represented by a relative value when the measurement result of the sample, in which the content of bismuth oxide (Bi₂O₃) in dielectric layer 8 is 40% by weight and the components contained in black electrodes 41b and 51b are chromium (Cr), manganese (Mn), and iron (Fe), is defined to be 1.

As a result, it is shown that the contact resistance is reduced when cobalt (Co), nickel (Ni) and copper (Cu), which are used in the exemplary embodiment of the present invention, are contained as the components of black electrodes 41b and 51b as compared with the case in which chromium (Cr), manganese (Mn) and iron (Fe) are contained as the components of black electrodes 41b and 51b. As mentioned above, this is thought to be because diffusion of the components of the conductive materials, black materials, or the like, contained in black electrodes 41b and 51b toward each electrode layer is reduced when cobalt (Co), nickel (Ni) and copper (Cu) are contained as components of black electrodes 41b and 51b, so that the contact of silver (Ag) particles cannot be prevented.

Furthermore, this contact resistance value is also dependent upon the content of bismuth oxide (Bi₂O₃) in dielectric layer 8. As shown in FIG. 5, when the amount of bismuth oxide (Bi₂O₃) is 25% by weight, the contact resistance value is reduced.

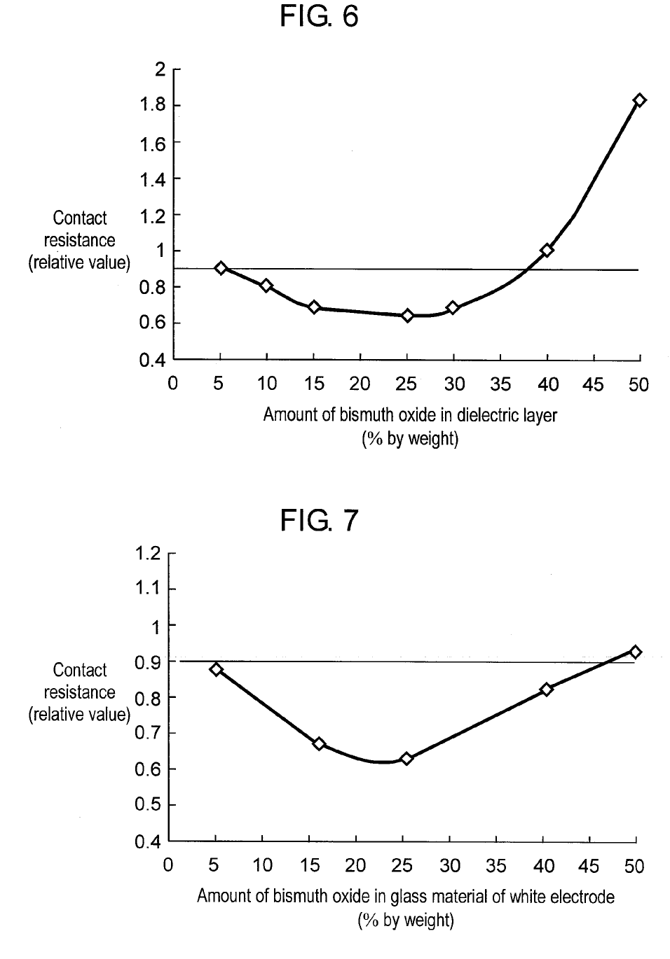

Furthermore, this exemplary embodiment examines the change of the contact resistance with respect to the content of bismuth oxide (Bi₂O₃) in the glass material of white electrodes 42b and 52b and the content of bismuth oxide (Bi₂O₃) in dielectric layer 8. These results are shown in FIGS. 6 and 7. FIG. 6 is a graph showing the change of the contact resistance value with respect to the content of bismuth oxide (Bi₂O₃) in dielectric layer 8 when the content of bismuth oxide (Bi₂O₃) in the glass material of white electrodes 42b and 52b is 25% by weight. On the other hand, FIG. 7 is a graph showing the change of the contact resistance value with respect to the content of bismuth oxide (Bi₂O₃) in the glass material of white electrodes 42b and 52b when the content of bismuth oxide (Bi₂O₃) in dielectric layer 8 is 25% by weight. Furthermore, similar to FIG. 4, the value is represented by a relative value when the measurement result of a sample in which the content of bismuth oxide (Bi₂O₃) in dielectric layer 8 is 40% by weight and the components contained in black electrodes 41b and 51b are chromium (Cr), manganese (Mn) and iron (Fe), is defined to be 1.

In the exemplary embodiment of the present invention, when the relative value of the contact resistance value is 0.9 or less, the increase amount of the resistance value in the entire display electrode is small and the effect on an applied voltage necessary to the image display can be reduced. As shown in FIG. 6, the contact resistance value is 0.9 or less when the content of bismuth oxide (Bi₂O₃) in dielectric layer 8 is in the range from 5% to 30% inclusive by weight. On the other hand, dielectric layer 8 is required to have a low dielectric constant from the viewpoint of reactive power at the time of discharging. Thus, it is further desirable that the content of bismuth oxide (Bi₂O₃) in dielectric layer 8 is 25% by weight or less. Therefore, it is desirable that a method of manufacturing a PDP includes a step of adding bismuth oxide (Bi₂O₃) to dielectric layer 8 in the content of 5% by weight or more and 25% by weight or less.

Furthermore, as shown in FIG. 7, the contact resistance value is 0.9 or less when the content of bismuth oxide (Bi₂O₃) in white electrodes 42b and 52b is 5% to 40% inclusive by weight. On the other hand, from the viewpoint of the softening point at the time of firing, it is further desirable that the content of bismuth oxide (Bi₂O₃) in white electrodes 42b and 52b is 25% by weight or less. Therefore, it is desirable that the content of bismuth oxide (Bi₂O₃) in the glass material of metal electrode layer is 5% by weight or more and 25% by weight or less.

As mentioned above, in this exemplary embodiment of the present invention, a method of manufacturing a PDP is a method of manufacturing a PDP including a front panel including display electrodes, light blocking layers, and a dielectric layer formed on a glass substrate, and a rear panel including electrodes, barrier ribs, and phosphor layers formed on a substrate, the front panel and the rear panel being disposed facing each other and sealed together at peripheries thereof with discharge space provided therebetween. The method includes forming the display electrodes by at least a plurality of layers including a metal electrode layer containing silver and a glass material, and a black layer containing a black material and a glass material; adding bismuth oxide (Bi₂O₃) to the dielectric layer in a content of 5% by weight or more and 25% by weight or less; and forming the dielectric layer by firing at a temperature ranging from 570° C. to 590° C. Furthermore, the method may further include adding at least one of cobalt (Co), nickel (Ni), copper (Cu), oxide of cobalt (Co), oxide of nickel (Ni), and oxide of copper (Cu) to the black layer. Furthermore, in the forming of the dielectric layer by firing a dielectric material, the light blocking layer contains a glass material and the dielectric material is fired at a temperature lower than a softening point of the glass material. Furthermore, the method may further include forming the light blocking layer by adding at least bismuth oxide (Bi₂O₃) to the glass material of the light blocking layer in the content of 5% by weight or more and 25% by weight or less. Thus, it is possible to reduce the contact resistance value of the display electrode and to realize a PDP having an excellent degree of black and having a high quality of image display. Furthermore, in the method of manufacturing a PDP in this exemplary embodiment of the present invention, a material cost can be reduced. Furthermore, it is possible to manufacture an environmentally friendly PDP that does not a lead (Pb) component.

### INDUSTRIAL APPLICABILITY

As mentioned above, the present invention can realize a PDP that has a high quality image display and is environmentally friendly. The PDP of the present invention is useful for a display device having a large screen.

1. A method of manufacturing a plasma display panel including a front panel including a display electrode, a light blocking layer, and a dielectric layer formed on a glass substrate, and a rear panel including an electrode, a barrier rib, and a phosphor layer formed on a substrate, the front panel and the rear panel being disposed facing each other and sealed together at peripheries thereof with discharge space provided therebetween,
the method comprising:
forming the display electrodes by at least a plurality of layers including a metal electrode layer containing silver and a glass material, and a black layer containing a black material and a glass material;
adding bismuth oxide (Bi₂O₃) to the dielectric layer in a content of 5% by weight or more and 25% by weight or less; and
forming the dielectric layer by firing at a temperature ranging from 570° C. to 590° C.

2. The method of manufacturing a plasma display panel of claim 1, further comprising:
adding at least one of cobalt (Co), nickel (Ni), copper (Cu), oxide of cobalt (Co), oxide of nickel (Ni), and oxide of copper (Cu) to the black layer.

3. The method of manufacturing a plasma display panel of claim 1, wherein in the forming of the dielectric layer by firing a dielectric material, the light blocking layer contains a glass material, and the dielectric material is fired at a temperature lower than a softening point of the glass material.

4. The method of manufacturing a plasma display panel of claim 2, wherein in the forming of the dielectric layer by firing a dielectric material, the light blocking layer contains a glass material, and the dielectric material is fired at a temperature lower than a softening point of the glass material.

5. The method of manufacturing a plasma display panel of claim 3, further comprising:
forming the light blocking layer by adding at least bismuth oxide (Bi₂O₃) to the glass material of the light blocking layer in a content of 5% by weight or more and 25% by weight or less.

6. The method of manufacturing a plasma display panel of claim 4, further comprising:
forming the light blocking layer by adding at least bismuth oxide (Bi₂O₃) to the glass material of the light blocking layer in a content of 5% by weight or more and 25% by weight or less.
